(19) United States
(12) Patent Application Publication
(10) Pub. No.: US 2026/0178734 A1
(43) Pub. Date: Jun. 25, 2026

(54) Classification Method, Classification Device And Classification Program

(71) Applicant: NAYUTAL PTE. LTD., Singapore (SG)

(72) Inventor: Shinichiro TAKAHASHI, Singapore (SG)

(73) Assignee: NAYUTAL PTE. LTD., Singapore (SG)

(21) Appl. No.: 18/990,645

(22) Filed: Dec. 20, 2024

(51) Int. Cl. G06F 21/56; G06F 21/50; H04L 9/40; G06F 21/55

(52) U.S. Cl. CPC G06F 21/562; G06F 21/50; G06F 21/565; H04L 63/14; H04L 63/1408; H04L 63/1416; H04L 63/1425; G06F 21/554

(57) ABSTRACT

To provide a classification method, a classification device and a classification program for detecting communications related to malware files from large-scale traffic data. A classification method for classifying content in network communications. The classification method includes receiving traffic data on communications, extracting an attached file from the traffic data, analyzing a type of the attached file, and analyzing whether or not the attached file contains malware by using a machine learning model suitable for the analyzed type of the attached file.

### TECHNICAL FIELD

The present invention relates to detection of communications related to malware files, and more particularly to a classification method, a classification device and a classification program for classifying contents of network communications.

### BACKGROUND ART

In recent years, attacks using various types of malwares have become frequent on the Internet.

In addition, the types of malwares are becoming more diverse every day, so methods for detecting such malware are desired.

Conventionally, there are a lot of software aimed at end points such as client terminals for detecting malware in communications content.

Furthermore, for large-scale traffic data, there are devices that detect malware contained in the traffic data by extracting IP addresses (see Patent Document 1).

### RELATED ART DOCUMENT

### PATENT DOCUMENT

Patent Document 1: JP-A 2018-148270

Patent Document 2: JP-A 2013-222422

### SUMMARY OF THE INVENTION

### PROBLEMS TO BE SOLVED BY THE INVENTION

However, there are a lot of malwares that cannot be identified using information other than files, such as IP addresses, and there is still no method or device that can extract these files from large-scale traffic data in real time and detect whether the extracted files contain malware.

The present invention has been made in consideration of the above. That is, an object of the present invention is to detect an abnormal attached file and communications thereof by extracting all attached files from large-scale traffic data and determining whether or not the attached documents are malware.

### MEANS FOR SOLVING THE PROBLEMS

In order to solve the above-mentioned problems and achieve the object, a first aspect of the present invention provides a method for classifying content in network communications. The classification method includes a step of receiving traffic data on communications, a step of extracting an attached file from the traffic data and a step of analyzing a type of the attached file, wherein in the analyzing step, a machine learning model suitable for the type of the attached file is used to analyze whether or not content of the attached file contains malware.

It is preferred that the classification method further includes a step of reconstructing the traffic data on a session unit and the step of extracting includes extracting detailed information of each session including the attached file.

It is further preferred that the classification method includes a step of outputting the detailed information of each session including the attached file extracted.

It is preferred that the step of analyzing the type of the attached file includes analyzing the content of the attached file for an attached file of non-secretive HTTP communications among the network communications and performing a type analysis of the attached file.

It is preferred that if the type of the attached file analyzed is apk or ipa, the classification method further includes a step of extracting static information from a manifest file or metadata of the attached file, wherein from the extracted static information, an analysis is made as to whether or not the content of the attached file is malware based on the machine learning model suitable for each type of the attached file.

A second aspect of the present invention provides a device for classifying content in network communications. The classification device includes a receiving unit that receives traffic data on communications, an extraction unit that extracts an attached file from the traffic data, a file type analysis unit that analyzes a type of the attached file and an analysis unit that uses a machine learning model suitable for the determined type of the attached file to analyze whether or not content of the attached file contains malware.

It is preferred that the classification device further includes a processing unit that reconstructs the traffic data on a session unit and the extraction unit extracts detailed information of each session including the attached file.

It is further preferred that the classification method includes an output unit that outputs the detailed information of each session including the attached file extracted.

It is preferred that the file type analysis unit analyzes the content of the attached file of non-secretive HTTP communications among the network communications and performs a type analysis of the attached file.

It is preferred that if the type of the attached file analyzed is apk or ipa, the extraction unit extracts static information from a manifest file or metadata of the attached file, and the file type analysis unit analyzes whether or not the content of the attached file is malware based on the machine learning model suitable for each type of the attached file form the extracted static information.

A third aspect of the present invention provides a classification program stored in a storage medium. The program causes a computer to execute a step of receiving traffic data on communications, a step of extracting an attached file from the traffic data, a step of analyzing a type of the attached file and a step of analyzing whether or not the attached file contains malware by using a machine learning model suitable for the analyzed type of the attached file.

### EFEECTS OF THE INVENTION

According to the present invention, it becomes easy to detect an abnormal attached file and communications thereof from large-scale of traffic data.

### BRIEF DESCRIPTION OF THE DRAWINGS

FIG. 1 is a schematic diagram showing a general configuration of a system including a classification device according to the present invention.

FIG. 2 is a flowchart showing processing steps of a file type analysis unit 12 in this embodiment.

FIG. 3 is a diagram showing an output example of an analysis result of communications including an attached file in this embodiment.

FIG. 4 is a diagram showing an output example of a malware determination model in this embodiment.

### MODE FOR CARRYING OUT THE INVENTION

An embodiment of the present invention will be described in detail with reference to the attached drawings.

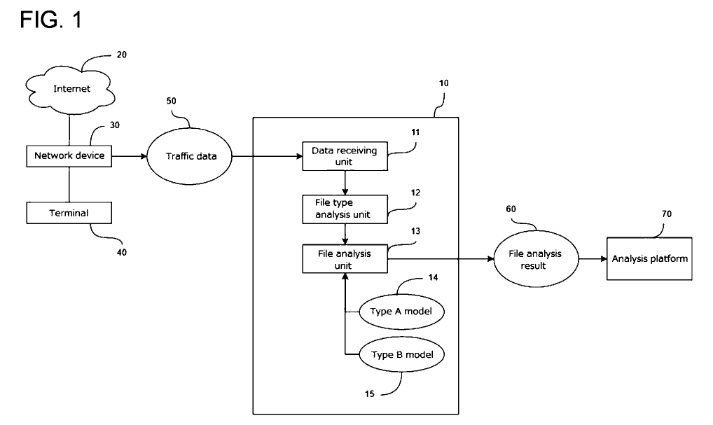

FIG. 1 is a schematic diagram showing a general configuration of a system including a classification device according to the present invention.

As shown in FIG. 1, a classification device 10 according to the embodiment includes a data receiving unit 11, an attached file extraction unit (not shown), a file type analysis unit 12, and a file analysis unit 13.

The data receiving unit 11 is mainly an OSS and is realized by Suricata. When Suricata receives traffic data, it outputs header information of communications including an IP address for each packet (including an HTTP header in the case of HTTP communications) in json format. Detailed information of this communications includes two identifiers, flow_id and tx_id. In addition, for communications determined by Suricata to be the HTTP communications, text or binary format attached files are also output. The number of attached files output is not limited to one; for example, in the case of a multipart request, there may be multiple attached files. The file names of the attached files are given flow_id and tx_id, and these two identifiers are used to link the detailed information of the communications with the attached files. The extraction unit (not shown) extracts the attached files from the communications received by the data receiving unit 11.

The file type analysis unit 12 reads each of the attached files output and extracted by the data receiving unit 11 and analyzes the file type thereof.

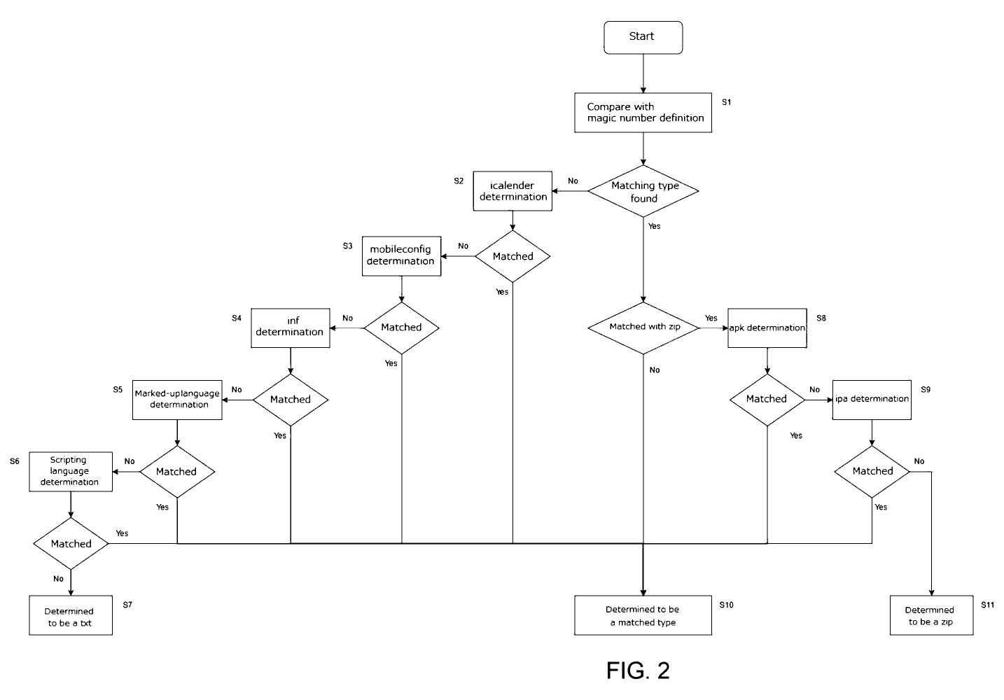

The processing steps of the file type analysis unit 12 is shown with reference to FIG. 2. First, in step S1, magic number defined files are referenced and compared to determine the file type. Magic number defined files contain three types of information for each type: file type (extension), hexadecimal string, and comparison start byte count. The hexadecimal string is converted into a byte string, and the converted byte string is compared forward with the byte string starting with the comparison start byte count in the attached file. If the comparison results in a match, the attached file is determined to be of that file type. If it does not match any of the file types, the process proceeds to step S2.

In step S2, a determination is made as to whether or not the attached file is an iCalendar file. The determination is made based on whether or not several characteristic descriptive parts contained in the iCalendar file are present in the attached file. If it is determined that the attached file is not the iCalendar, the process proceeds to step S3.

In step S3, a determination is made as to whether or not the attached file is a mobileconfig file. The determination is made based on whether or not several characteristic descriptive parts contained in the mobileconfig file are present in the attached file. If it is determined that the attached file is not the mobileconfig, the process proceeds to step S4.

In step S4, a determination is made as to whether or not the attached file is an inf file. The determination is made based on whether or not several characteristic description parts contained in the inf file are present in the attached file. If it is determined that the attached file is not the inf file, the process proceeds to step S5.

In S5, a determination is made as to whether or not the attached file is in a marked-up language. In this embodiment, the marked-up language refers to any of wsf, aspx, jsp, html and css. The determination is made based on whether or not several characteristic descriptive parts contained in each marked-up language are present in the attached file. If it is determined that the attached file is not one of the marked-up languages, the process proceeds to step S6.

In step S6, a determination is made as to whether or not the attached file is a program file written in a scripting language. In this embodiment, the scripting language refers to any of AutoIt, bat, F#, JavaScript, Lua, Perl, Raku (Perl6), PHP, PowerShell, Python, Ruby, ShellScript and VBScript. The determination is made based on the classification results of a rule-based classification model that defines the characteristic syntax of each language. If it is determined that the attached file is not one of the scripting languages, it is determined to be a txt file (S7).

The process then returns to step S1, and if the attached file is determined to be a zip file, the process proceeds to step S8. In step S8, a determination is made as to whether or not the attached file is an Android application executable file (apk). The attached file is developed on a memory, and a determination is made based on whether or not AndroidManifest.xml exists in a specified directory. If these exist, the attached file is determined to be the apk file. If they do not exist, the attached file is deemed not to be the apk file, and the procedure proceeds to step S9.

In step S9, a determination is made as to whether or not the attached file is an iOS application executable file (ipa). The attached file is developed on a memory, and a determination is made based on whether or not either the file Info.plist or embedded.mobileprovision exists in a specified directory. If either of the above exists, it is determined to be the ipa file. If neither of the above exists, the attached file is considered not to be the ipa file and is determined to be a zip file.

Based on the file type determined by file type analysis unit 12, file analysis unit 13 predicts whether or not the attached file contains malware for communications that contain the target file type. A method for predicting malware in the attached file is described below.

Static information is obtained from a manifest file and metadata contained in the attached file, and this information is used to predict whether or not the attached file is malware using a machine learning model corresponding to the file type.

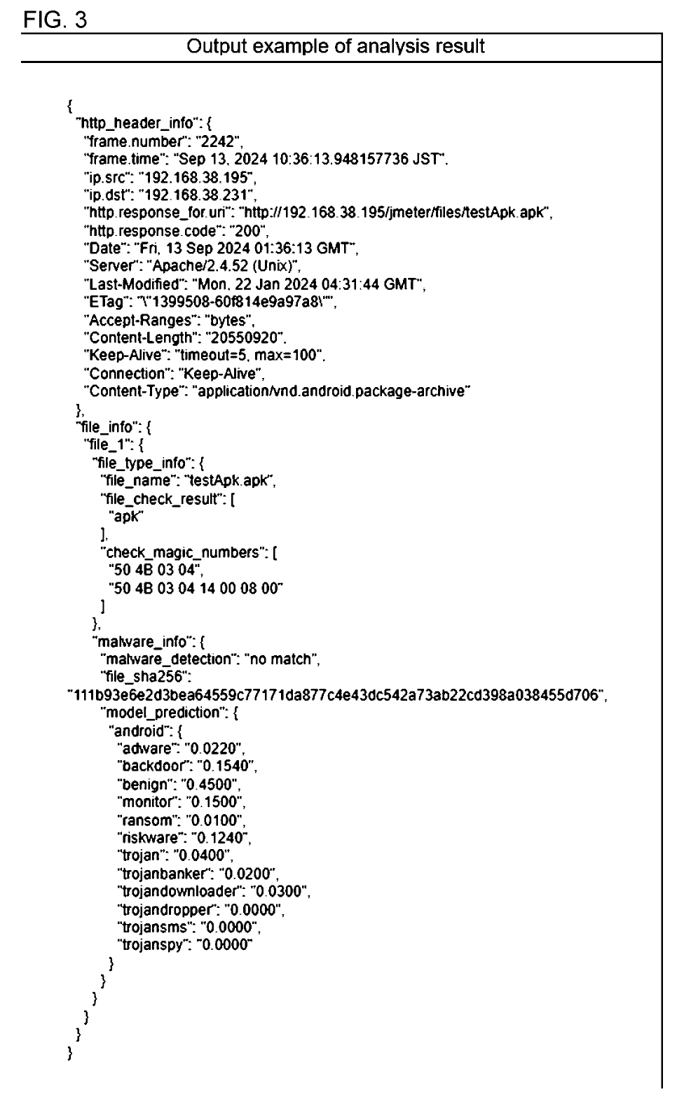

For example, for apk files, there is a machine learning model created by a method such as that described in Patent Document 2. The machine learning models for each file type are either multi-class classification models that output the probability of a specific malware type as a numerical value or binary classification models that output the probability of malware and the probability of not being malware as numerical values. An output example of these models is shown in FIG. 3. “benign” represents a class that is not malware. This implementation method is applied to two types of models: apk file model 14 and ipa file model 15. The apk file model is created by referring to, for example, Patent Documents 1 and 2. In addition, for the ipa file model, provision information is obtained from embedded.mobileprovision and plist information is obtained from Info.plist described in paragraph 0031 of the specification of Patent Document 2, and a machine learning model is created based on these.

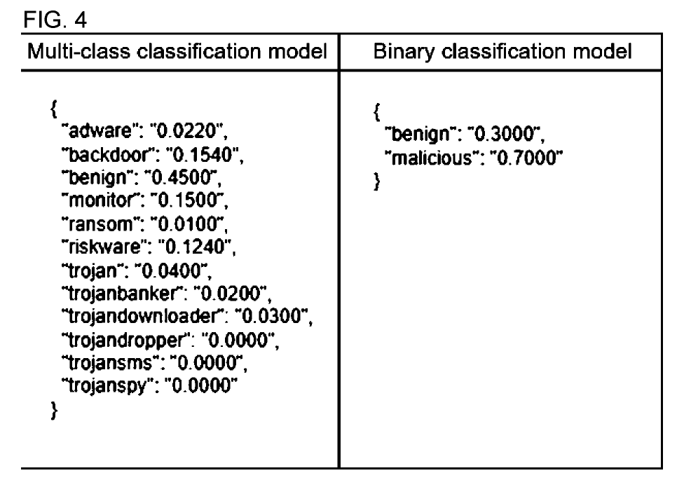

Further, a determination result and header information of the communications acquired by the data receiving unit 11 are output together to a file 60 in json format. An output example is shown in FIG. 4.

A probability calculated by the prediction using the above-mentioned model is used by an analysis platform 70 to determine whether or not the attached file is malware, based on a specified threshold value.

The above method makes it easy to detect abnormal attached files and their communications from large-scale traffic data.

In the present invention, a program for causing the classification device or other device to realize any of the above functions can be recorded on a recording medium readable by a computer or the like. The functions can then be provided by having a computer or the like read and execute the program from this recording medium. Furthermore, the functions described as being realized by the classification device may be realized by a single computer, or may be shared among multiple computers.

Although the present invention has been described above using embodiments, it goes without saying that the technical scope of the present invention is not limited to the scope described in the above embodiments. It will be apparent to those skilled in the art that various modifications and improvements can be made to the above embodiments. It is also apparent from the claims that forms incorporating such modifications or improvements may be included within the technical scope of the present invention.

### REFFERENCE SIGNS LIST

10 Classification device

11 Data receiving unit

12 File type analysis unit

13 File analysis unit

14 Type A model

15 Type B model

20 Internet

30 Network device

40 Terminal

50 Traffic data

60 File analysis result

70 Analysis platform

What is claimed is:

1. A classification method for classifying content in network communications, the classification method comprises:
receiving traffic data on communications,
extracting an attached file from the traffic data, and
analyzing a type of the attached file,
wherein in analyzing the type of the attached file, a machine learning model suitable for the type of the attached file is used to analyze whether or not content of the attached file contains malware.

2. The classification method as claimed in claim 1, further comprising reconstructing the traffic data on a session unit,
wherein extracting the attached file includes extracting detailed information of each session including the attached file.

3. The classification method as claimed in claim 2, further comprising outputting the detailed information of each session including the attached file extracted.

4. The classification method as claimed in claim 1, wherein analyzing the type of the attached file includes analyzing the content of the attached file for an attached file of non-secretive HTTP communications among the network communications and performing a type analysis of the attached file.

5. The classification method as claimed in claim 1, wherein if the type of the attached file analyzed is apk or ipa, the classification method further comprises extracting static information from a manifest file or metadata of the attached file, and
wherein from the extracted static information, an analysis is made as to whether or not the content of the attached file is malware based on the machine learning model suitable for each type of the attached file.

6. A classification device for classifying content in network communications, the classification device comprises:
a receiving unit that receives traffic data on communications,
an extraction unit that extracts an attached file from the traffic data,
a file type analysis unit that analyzes a type of the attached file, and
an analysis unit that uses a machine learning model suitable for the determined type of the attached file to analyze whether or not content of the attached file contains malware.

7. The classification device as claimed in claim 6, further comprising a processing unit that reconstructs the traffic data on a session unit,
wherein the extraction unit extracts detailed information of each session including the attached file.

8. The classification device as claimed in claim 7, further comprising an output unit that outputs the detailed information of each session including the attached file extracted.

9. The classification device as claimed in claim 6, wherein the file type analysis unit analyzes the content of the attached file of non-secretive HTTP communications among the network communications and performs a type analysis of the attached file.

10. The classification device as claimed in claim 6, wherein if the type of the attached file analyzed is apk or ipa, the extraction unit extracts static information from a manifest file or metadata of the attached file, and
wherein the file type analysis unit analyzes whether or not the content of the attached file is malware based on the machine learning model suitable for each type of the attached file form the extracted static information.

11. A classification program stored in a storage medium, the classification program causing a computer to execute:
receiving traffic data on communications,
extracting an attached file from the traffic data,
analyzing a type of the attached file, and
analyzing whether or not the attached file contains malware by using a machine learning model suitable for the analyzed type of the attached file.
